(19) United States
(12) Patent Application Publication
(10) Pub. No.: US 2004/0228061 A1
(43) Pub. Date: Nov. 18, 2004

(54) Protector and lithium secondary battery having the same

(75) Inventors: Ju-hyung Kim, Cheonan-city (KR); Un-Sick Park, Seongnam-city (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd, Kyungki-do (KR)

(21) Appl. No.: 10/727,714

(22) Filed: Dec. 5, 2003

(30) Foreign Application Priority Data
Dec. 26, 2002 (KR) 10-2002-84072

(51) Int. Cl. H02H 5/04

(52) U.S. Cl. 361/103

(57) ABSTRACT

A protector, and a lithium secondary battery having the protector, includes a positive temperature coefficient element (PTC) for interrupting current induced due to increased resistance when the temperature rises, a first lead made of aluminum or an aluminum alloy, and a second lead as an output terminal led from the PTC and made of nickel or a nickel alloy.

### CROSS-REFERENCE TO RELATED APPLICATION

This application claims the benefit of Korean Patent Application No.2002-84072, filed on Dec. 26, 2002 in the Korean Intellectual Property Office, the disclosure of which is incorporated herein in its entirety by reference.

### BACKGROUND OF THE INVENTION

1. Field of the Invention

The present invention relates to a protector and a lithium secondary battery having the same, and more particularly, a lithium secondary battery having an improved electrical connection structure between a protector of the battery and a can.

2. Description of the Related Art

In general, lithium secondary batteries are rechargeable and can be made into a smaller size with a high capacity. The lithium secondary batteries are widely used in advanced electronic devices such as mobile phones, camcorders, notebook type computers and the like because of their various advantages, including high operating voltage and high-energy density.

A lithium secondary battery is generally formed by accommodating a generation element comprising a positive electrode plate, a negative electrode plate and a separator as an electrode unit. The electrode unit and an electrolytic solution are placed in a can, and an upper opening of the can is sealed using a cap assembly. The can is made of aluminum or an aluminum alloy since aluminum is lightweight, which is advantageous in attaining lightweight batteries. Aluminum is also highly resistant to corrosion, even when it is used for a long time at high voltages as compared to iron or other conductive metals. The lithium secondary battery generally has an electrode terminal formed at an upper portion and insulated from the can. The electrode terminal serves as one electrode of the battery. In this case, the can of the battery (e.g., the bottom surface of the battery) serves as the other electrode of the battery.

In the event of an external short-circuit, an internal short-circuit due to mechanical impacts, or overcharging, the lithium secondary battery is prone to rupture due to a sharp increase in the voltage of the battery. To avoid such a danger, the lithium secondary battery is generally electrically connected to a safety device, such as a positive temperature coefficient (PTC) element, a thermal fuse, or a protecting circuit. The safety device (also called a protector) is then encased in a battery pack. The safety device prevents rupture of a battery by interrupting current flow when the voltage of the battery sharply increases.

The safety device of a battery is generally connected to positive and negative electrodes of the battery through a lead. The lead is generally made of nickel, a nickel alloy or nickel-plated stainless steel to provide a predetermined level of hardness and conductivity. However, a lead made of nickel or a nickel alloy may cause several problems when it is welded to a can made of aluminum or an aluminum alloy. In other words, the infusibility of nickel makes it difficult to perform ultrasonic welding. In addition, the high electrical, thermal conductivity of aluminum makes it difficult to perform resistance welding due to difficulty of the intensive heat formed at the contact interface. Thus, laser welding may be employed. During laser welding, however, laser beams may be transferred to the safety device, resulting in poor reliability.

To overcome the above problems, a battery shown in FIG. 1 (an example of which is more fully set forth in U.S. Pat. No. 5,976,729) has a safety device, such as a protector 4, connected thereto. A bottom plate 2 made of nickel or a nickel alloy is laser-welded to a bottom surface 1a of a can 1. The can 1 is made of aluminum or an aluminum alloy. A lead 3 is welded to the bottom plate 2 with a welding device 5 by resistance welding.

However, according to the shown battery, since the lead 3 is connected to the can 1 using the bottom plate 2, the process is complex and the manufacturing cost increases. Also, since the bottom plate 2 used in connecting the lead 3 is made of nickel or a nickel alloy having relatively higher electrical resistance than aluminum, a voltage drop of the overall battery may increase due to an increase in electrical resistance at the plate 2.

### SUMMARY OF THE INVENTION

An aspect of the invention provides a protector having an improved connection structure for reducing the cost and a voltage drop of the battery and a lithium secondary battery having the protector.

Additional aspects and/or advantages of the invention will be set forth in part in the description which follows and, in part, will be obvious from the description, or may be learned by practice of the invention.

In accordance with an aspect of the present invention, a lithium secondary battery includes a can made of a conductive metal and in which an electrode unit having positive and negative electrode plates with a separator interposed therebetween is housed with an electrolytic solution, an upper opening is sealed by a cap assembly, a positive temperature coefficient element (PTC) for interrupting current induced due to increased resistance when the temperature rises, a first lead made of aluminum or an aluminum alloy and electrically connecting a terminal at an outer bottom surface of the can with the PTC, and a second lead electrically connecting the PTC with a protecting circuit attached to another terminal or the another terminal.

In accordance with another aspect of the present invention, a lithium secondary battery includes a can made of a conductive metal and in which an electrode unit having positive and negative electrode plates with a separator interposed therebetween is housed with an electrolytic solution, an upper opening is sealed by a cap assembly, a positive temperature coefficient element (PTC) for interrupting current induced due to increased resistance when the temperature rises, a first lead having a nickel layer made of nickel or a nickel alloy and a clad layer formed on the bottom surface of the nickel layer, the first lead electrically connecting a terminal of an outer bottom surface of the can with the PTC, and the second lead electrically connecting the PTC with a protecting circuit attached to another terminal or the another terminal.

In accordance with still another aspect of the present invention, a lithium secondary battery includes a can made of a conductive metal and in which an electrode unit having positive and negative electrode plates with a separator interposed therebetween is housed with an electrolytic solution, an upper opening is sealed by a cap assembly, a positive temperature coefficient element (PTC) for interrupting current induced due to increased resistance when the temperature rises, an input lead connected to the PTC and made of nickel or nickel alloy, a first lead having a nickel layer made of nickel or a nickel alloy, and a clad layer made of aluminum or an aluminum alloy on the bottom surface of the nickel layer, the first lead electrically connecting a terminal on an outer bottom surface of the can with the input lead, and a second lead made of nickel or a nickel alloy and electrically connecting the PTC with a protecting circuit attached to another terminal or the another terminal.

According to an aspect of the invention, the can is made of aluminum or an aluminum alloy.

According to an aspect of the invention, a safety vent for exhausting internal gas when pressure inside the can increases, is provided at one of the upper portion of the can and the cap assembly.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating a conventional secondary battery;

FIG. 2 is an exploded perspective view of a lithium secondary battery according to an embodiment of the present invention;

FIG. 3 is an exploded perspective view of a lithium secondary battery according to an embodiment of the present invention having a protector connected thereto;

FIGS. 4A and 4B are cross-sectional views illustrating a connection structure of the protector shown in FIG. 3;

FIGS. 5A and 5B are partial cross-sectional views of a lithium secondary battery according to another embodiment of the present invention having a protector connected thereto; and

FIGS. 6A and 6B are partial cross-sectional views of a lithium secondary battery according to still another embodiment of the present invention having a protector connected thereto.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

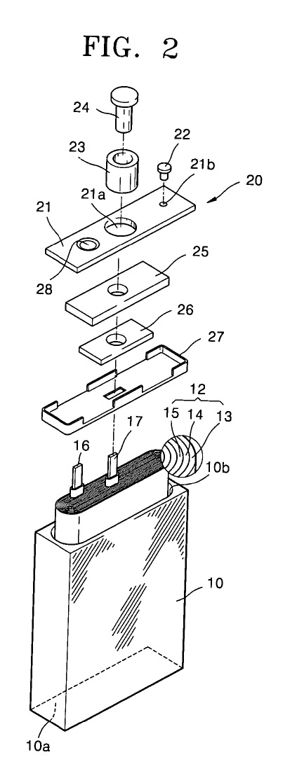

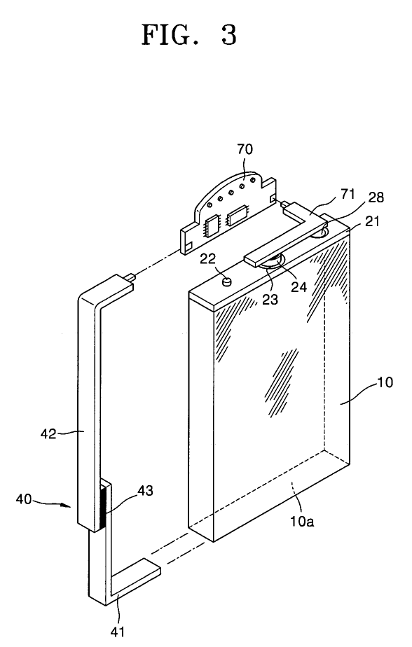

As shown in FIGS. 2 and 3, a lithium secondary battery according to an embodiment of the present invention includes a can 10. An electrode unit 12 is disposed inside the can 10 with an electrolytic solution so as to provide a generation element to generate electrical power. A cap assembly 20 is sealed to an upper opening 10b of the can 10. A protector 40 is provided at one side of the can 10 and is electrically connected to the can 10. It is understood that the generation element could comprise a solid electrolyte instead of or in addition to the electrolytic solution.

According to the shown embodiment, the can 10 is a substantially rectangular metal, and serves as a terminal itself. The can 10 is formed of aluminum, which is a light, conductive metal, or an aluminum alloy. However, it is understood that the can 10 can be other shapes and other materials can be used for the can 10. In the shown embodiment, the can 10 has one plane opened to provide the opening 10b. During assembly, the electrode unit 12 is accommodated inside the can 10 through the opening 10b.

The electrode unit 12 includes a positive electrode plate 13, a negative electrode plate 15 and a separator 14. The separator 14 is disposed between the positive electrode plate 13 and the negative electrode plate 15. Then, the resultant stacked structure is wound in a jelly-roll type. A positive electrode lead 16 is welded to the positive electrode plate 13. An end of the positive electrode lead 16 protrudes upward from the electrode unit 12. Also, a negative electrode lead 17 is welded to the negative electrode plate 15. An end of the negative electrode lead 17 also protrudes upward from the electrode unit 12. However, it is understood that other forms of electrode units 12 can be used beyond the example jelly-roll type unit.

A cap plate 21 is provided in the cap assembly 20. The cap plate 21 is a metal plate having the size and shape corresponding to the size and shape of the opening 10b of the can 10. A terminal throughhole 21a having a predetermined size is formed at the center of the cap plate 21. An electrode terminal is insertably disposed at the terminal throughhole 21a to provide a negative electrode terminal 24. A tubular gasket 23 is installed at the outer surface of the negative electrode terminal 24 and insulates between the negative electrode terminal 24 and the cap plate 21. A terminal plate 26 is installed under the insulation plate 25. The bottom of the negative electrode terminal 24 is electrically connected to the terminal plate 26. An insulation case 27 is installed above the electrode unit 12 and insulates between the electrode unit 12 and the cap assembly 20. After the cap assembly 20 is welded to the opening 10b of the can 10, an electrolytic solution is injected into the electrode unit 12 through an inlet 21b formed at the cap plate 2. The inlet 21b is sealed using a plug 22.

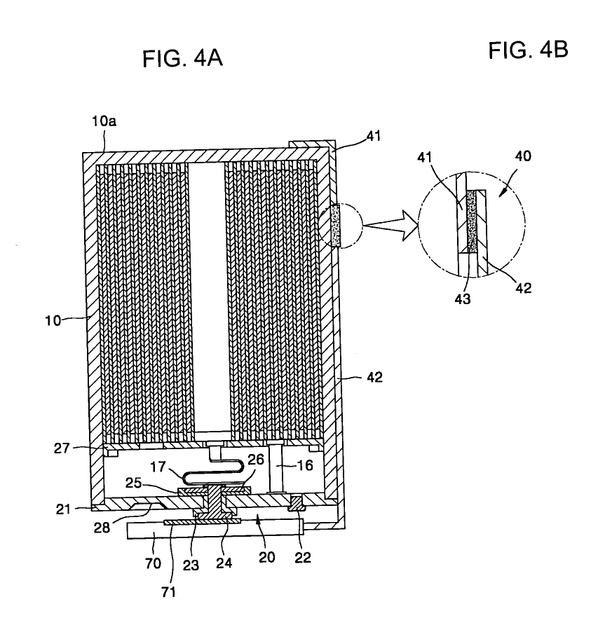

According to an embodiment of the present invention, shown in FIGS. 3 through 4B, a protector 40 is provided at one side of the can 10. The protector 40 includes a positive temperature coefficient element (PTC) 43 for interrupting current induced due to increased resistance when the temperature rises. The PTC 43 is electrically connected to an outer bottom 10a of the can 10 through a first lead 41 and is electrically connected to a protecting circuit 70 for preventing overcharging and overdischarging through a second lead 42. The protecting circuit 70 and the negative electrode terminal 24 are also electrically connected to each other through a third lead 71. However, the electrical connection structures shown in FIGS. 3 and 4 are provided for illustration only, and the protector 40 may be directly connected to the terminal 24 without the protecting circuit 70 according to an aspect of the invention.

According to an aspect of the present invention, the first lead 41 is made of aluminum or an aluminum alloy, and the second lead 42 is made of nickel or a nickel alloy. Where the outer bottom surface 10a of the can 10 and the first lead 41 are made of aluminum, since aluminum is more fusible than nickel, the first lead 41 can be adhered to the surface 10a by ultrasonic welding with a sufficiently high weld strength. However, it is understood that other material or materials could be used for the leads 41, 42.

The lithium secondary battery according to the shown aspect of the present invention includes a safety vent 28 which ensures safety of the battery by exhausting internal gas when pressure inside the can 10 increases due to overcharging. The safety vent 28 is thinner than other parts of the can 10 and is first ruptured when the internal pressure increases, thereby exhausting internal gas. While possible according to an aspect of the invention, if such a safety vent 28 is provided at the outer bottom surface 10a of the can 10, the safety vent 28 may be damaged during formation. That is, during initial charge/discharge tests of a lithium secondary battery, a test probe supports the outer bottom surface 10a of the can 10 and the safety vent 28 may be damaged by a leading edge of the test probe. Thus, the safety vent 28 is provided at the upper portion of the can 10 in the shown embodiment in FIGS. 3 through 4B. Preferably, the safety vent 28 is provided on the cap plate 21 of the cap assembly 20. However, it is understood that the safety vent 28 can be disposed elsewhere, and that other mechanisms can be used to prevent an internal pressure from exceeding a predetermined amount.

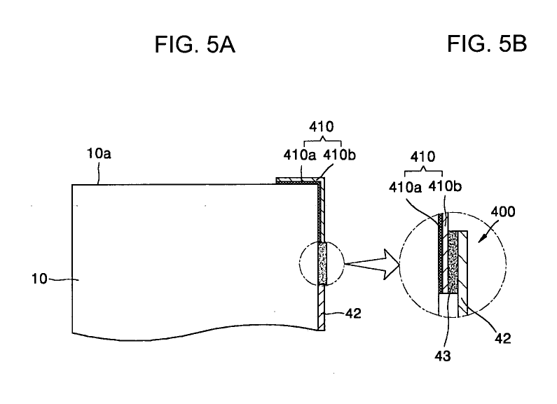

FIGS. 5A and 5B are partial cross-sectional views of the connection structure of a lithium secondary battery according to another embodiment of the present invention having a protector 400 connected thereto. The same reference numerals shown in FIGS. 4A and 4B denote elements having similar functions and operations, and an explanation thereof will not be given. A first lead 410 is electrically connecting an outer bottom surface 10a of a can 10. The first lead 410 includes a nickel layer 410b made of nickel or a nickel alloy. The nickel layer 410b contacts the PTC 43. The first lead 410 also has a clad layer 410a formed on the bottom surface of the nickel layer 410b. The clad layer 410a is made of aluminum or an aluminum alloy. A second lead 42 is electrically connected to the PTC 43 and a protecting circuit 70, which is attached to the terminal 24 shown in FIG. 4A, or the terminal 24 shown in FIG. 4A. The second lead 42 includes an output lead made of nickel or a nickel alloy. Since the outer bottom surface 10a of the can 10 and the clad layer 410a of the first lead 410 are made of aluminum and since aluminum is more fusible than nickel, the outer bottom surface 10a and the clad layer 410a can be adhered to each other by ultrasonic welding with a sufficient high weld strength.

Like in the above-described embodiment in FIGS. 2 through 4A, a safety vent 28 shown in FIG. 4A is provided at the upper portion of the can 10 according to an aspect of the invention. Preferably, the safety vent 28 is provided on a cap plate 21 of the cap assembly 20 shown in FIG. 4A.

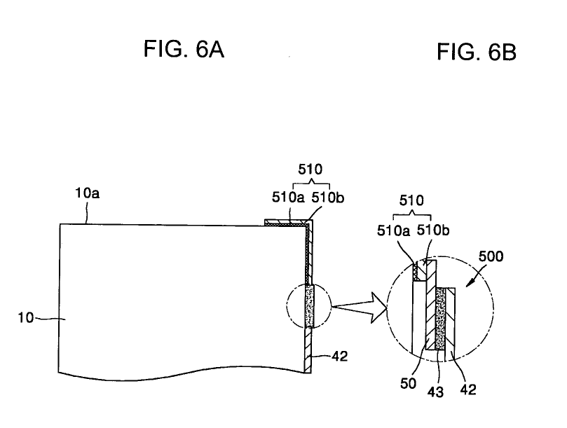

FIGS. 6A and 6B are partial cross-sectional views of the connection structure of a lithium secondary battery according to still another embodiment of the present invention having a protector 500 connected thereto. The same reference numerals shown in FIGS. 4A through 5B denote elements having similar functions and operations, and an explanation thereof will not be given. The protector 500 further includes an input lead 50 connected to the PTC 43 and which is made of nickel or nickel alloy. The input lead 50 of the protector 500 is electrically connected to an outer bottom surface 10a of the can 10 by a first lead 510.

The first lead 510 includes a clad layer 510a made of aluminum or an aluminum alloy. The first lead 510 further includes a nickel layer 510b formed on the clad layer 510a and which is made of nickel or a nickel alloy. Like in the above-described embodiment in FIGS. 4A through 5B, a second lead 42 electrically connects the PTC 43 and the protecting circuit 70 attached to the terminal 24 or to the terminal 24 shown in FIG. 4A. The second lead 42 is made of nickel or a nickel alloy. Since the outer bottom surface 10a of the can 10 and the clad layer 510a of the first lead 510 are made of aluminum and since aluminum is more fusible than nickel, the outer bottom surface 10a and the clad layer 510a can be adhered to each other by ultrasonic welding with a sufficient high weld strength.

Also, like in the above-described embodiments in FIGS. 4A through 5B, a safety vent 28 shown in FIG. 4A is provided at the upper portion of the can 10 according to an aspect of the invention. The safety vent 28 exhausts internal gas when the pressure inside the can 10 increases beyond a predetermined threshold. While not required in all aspects, the safety vent 28 is preferably provided on a cap plate 21 of the cap assembly 20 shown in FIG. 4A.

While described in terms of specific welding techniques by way of example, it is understood that other welding techniques could be used and/or other attachment mechanisms could be used.

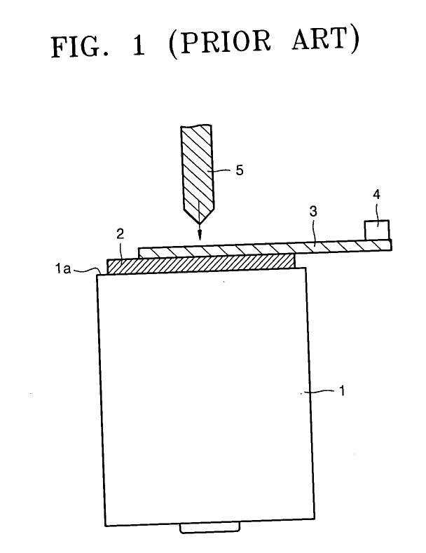

As described above, the protector according to embodiments of the present invention and a lithium secondary battery having the protector have the following and/or other advantages. Since a bottom plate is not necessary according to an aspect of the present invention, unlike in the conventional device such as that shown in FIG. 1, the manufacturing process becomes simplified and the manufacturing cost can be reduced accordingly. Also, since a can and a lead are directly adhered to each other according to an aspect of the present invention, a voltage drop of the battery can be minimized.

While this invention has been particularly shown and described with reference to embodiments thereof, it will be understood by those skilled in the art that various changes in form and details may be made therein without departing from the spirit and scope of the invention as defined by the appended claims and their equivalents.

What is claimed is:

1. A protector for use in a battery comprising:
a positive temperature coefficient element (PTC) having an input terminal and an output terminal and which has an increased resistance as a temperature of the PTC rises so as to interrupt a current passing between the input and output terminals;
a first lead made of aluminum or an aluminum alloy and which is connected to the input terminal and connectable to a terminal of the battery; and
a second lead made of nickel or a nickel alloy and which is connected to the output terminal and connectable to another terminal of the battery.

2. A protector for use in a battery comprising:
a positive temperature coefficient element (PTC) having an input terminal and an output terminal and which has an increased resistance as a temperature of the PTC rises so as to interrupt a current passing between the input and output terminals;
a first lead connected to the input terminal and connectable to a terminal of the battery, the first lead comprising a first layer comprising nickel or a nickel alloy and which contacts the PTC, and a second layer on the first layer and comprising aluminum or an aluminum alloy; and
a second lead connected to the output terminal and connectable to another terminal of the battery, the second lead comprising nickel or a nickel alloy.

3. A lithium secondary battery comprising:
a can in which an electrode unit having positive and negative electrode plates with a separator interposed therebetween is housed with an electrolytic solution, the can comprising a conductive metal and having an upper opening that is sealed by a cap assembly having a first terminal electrically connected to one of the positive and negative electrode plates, and an outer bottom surface having a second terminal electrically connected to the other one of the positive and negative electrode plates;
a positive temperature coefficient (PTC) having an increased resistance when a temperature of the PTS rises so as to interrupt a current passing therethrough;
a first lead comprising aluminum or an aluminum alloy and which electrically connects the second terminal at the outer bottom surface with the PTC; and
a second lead comprising nickel or a nickel alloy and which electrically connects the PTC with a protecting circuit attached to the first terminal or the first terminal.

4. The lithium secondary battery of claim 3, wherein the conductive metal of the can comprises aluminum or an aluminum alloy.

5. The lithium secondary battery of claim 3, further comprising a safety vent for exhausting internal gas when pressure inside the can increases past a predetermined level and which is provided at one of an upper portion of the can and the cap assembly.

6. A lithium secondary battery comprising:
a can in which an electrode unit having positive and negative electrode plates with a separator interposed therebetween is housed with an electrolytic solution, the can comprising a conductive metal, an upper opening that is sealed by a cap assembly having a first terminal electrically connected to one of the positive and negative electrode plates, and an outer bottom surface having a second terminal electrically connected to the other one of the positive and negative electrode plates;
a positive temperature coefficient element (PTC) having an increased resistance as a temperature of the PTC rises so as to interrupt a current passing therethrough;
a first lead having a nickel layer made of nickel or a nickel alloy and a clad layer formed on a bottom surface of the nickel layer, the first lead electrically connecting the second terminal of the outer bottom surface of the can with the PTC; and
a second lead made of nickel or a nickel alloy and which electrically connects the PTC with a protecting circuit attached to the first terminal or the first terminal.

7. The lithium secondary battery of claim 6, wherein the conductive metal of the can is comprises aluminum or an aluminum alloy.

8. The lithium secondary battery of claim 6, further comprising a safety vent for exhausting internal gas when pressure inside the can increases past a predetermined level and which, is provided at one of an upper portion of the can and the cap assembly.

9. A lithium secondary battery comprising:
a can in which an electrode unit having positive and negative electrode plates with a separator interposed therebetween is housed with an electrolytic solution, the can comprising a conductive metal, an upper opening that is sealed by a cap assembly having a first terminal electrically connected to one of the positive and negative electrode plates, and an outer bottom surface having a second terminal electrically connected to the other one of the positive and negative electrode plates;
a positive temperature coefficient element (PTC) having an increased resistance as a temperature of the PTC rises so as to interrupt a current passing therethrough;
an input lead connected to the PTC and comprising nickel or a nickel alloy;
a first lead having a nickel layer made of nickel or a nickel alloy, and a clad layer made of aluminum or an aluminum alloy on a bottom surface of the nickel layer, the first lead electrically connecting the second terminal of the outer bottom surface of the can with the input lead; and
a second lead made of nickel or a nickel alloy and electrically connecting the PTC with a protecting circuit attached to the first terminal or the first terminal.

10. The lithium secondary battery of claim 9, wherein the conductive material of the can comprises aluminum or an aluminum alloy.

11. The lithium secondary battery of claim 9, further comprising a safety vent for exhausting internal gas when pressure inside the can increases past a predetermined level and, is provided at one of an upper portion of the can and the cap assembly.

12. A lithium battery comprising:
a generation element which generates electrical power;
a can which houses the generation element and which has a first surface and a second surface, the first surface comprising a first terminal electrically connected to the generation element and the second surface comprising a second terminal electrically connected to the generation element; and
a lead unit which electrically connects the first terminal and the second terminal through a safety device and having a lead plate with one end disposed at the first surface and another end disposed at the safety device.

13. The lithium battery of claim 12, wherein the can comprises a first material and the lead plate comprises the first material.

14. The lithium battery of claim 13, wherein the lead unit further comprises another lead plate electrically connecting the safety device and the second terminal, the another lead plate comprising a second material other than the first material.

15. The lithium battery of claim 12, further comprising a safety vent which exhausts internal gas when pressure inside the can increases past a predetermined level, the safety vent being at the second surface of the can.

16. The lithium battery of claim 15, wherein:
the can further comprises an opening through which the generation element is introduced into the can, and a cap which closes the opening, and
the safety vent is disposed on the cap.

17. The lithium battery of claim 12, wherein the safety device interrupts current flowing therethrough when a voltage of the battery sharply increases.

18. The lithium battery of claim 17, further comprising a protecting circuit which prevents overcharging and over discharging and which is electrically connected by the lead unit between the safety device and the second terminal.

19. The lithium battery of claim 18, wherein the lead unit further comprises another lead plate that electrically connects the safety device and the protecting circuit and which comprises the second material.

20. The lithium battery of claim 19, wherein the lead unit further comprises a third lead plate electrically connecting the protecting circuit and the second terminal.

21. The lithium battery of claim 13, wherein the can comprises a first material, the one end of the lead plate comprises the first material, and the other end of the lead plate comprises a second material other than the first material.

22. The lithium battery of claim 21, wherein the one end of the lead plate further comprises a first layer comprising the second material, and a second layer of the first material disposed between the first layer and the first surface of the can.

23. The lithium battery of claim 22, wherein the second layer contacts the first terminal.

24. The lithium battery of claim 22, wherein the other end of the lead plate comprises the first layer of the second material and the first layer contacts the safety device.

25. The lithium battery of claim 22, wherein the lead unit further comprises an input lead of the second material and which connects the safety device and the other end of the lead plate.

26. The lithium battery of claim 24, wherein the safety device interrupts current flowing therethrough when a voltage of the battery sharply increases.

27. The lithium battery of claim 12, wherein the lead plate is attached to the first surface using ultrasonic welding.

28. The lithium battery of claim 12, wherein the lead plate is attached to the first surface using resistance welding.

29. A protector for use in a battery comprising:
a safety device which interrupts current passing through the safety device when a voltage of the battery sharply increases;
a first lead which is connected to the safety device and which comprises a first material at an end of the first lead that is connectable to a terminal of the battery comprising the first material; and
a second lead which is connected to the safety device and is connectable to another terminal of the battery.

30. The protector of claim 29, wherein the second lead comprises a second material other than the first material.

31. The protector of claim 29, wherein the first lead comprises a first layer comprising a second material other than the first material and which contacts the safety device, and a second layer comprising the first material disposed so as to contact the another terminal of the battery at the end of the first lead.

32. The protector of claim 29, further comprising an input lead of a second material other than the first material and which connects the safety device and the first lead.
